(19) United States
(12) Patent Application Publication
(10) Pub. No.: US 2018/0124002 A1
(43) Pub. Date: May 3, 2018

(54) ENHANCED IS-TYPING INDICATOR

(71) Applicant: Microsoft Technology Licensing, LLC, Redmond, WA (US)

(72) Inventors: Casey Baker, Seattle, WA (US); Jose Alberto Rodriguez, Seattle, WA (US)

(21) Appl. No.: 15/469,832

(22) Filed: Mar. 27, 2017

Related U.S. Application Data
(60) Provisional application No. 62/416,096, filed on Nov. 1, 2016.

(51) Int. Cl. H04L 12/58

(52) U.S. Cl. CPC H04L 51/24; H04L 51/04

(57) ABSTRACT

Technology is disclosed herein that improves the user experience with respect to is-typing animations. In an implementation, a near-end client application receives an indication that a user is typing in a far-end client application. The near-end client application responsively selects an animation that is representative of a typing pattern. The selection may be random in some implementations (or pseudo random), or the selection may correspond to a particular typing pattern. The near-end client then manipulates the ellipses in its user interface to produce the selected animation.

### RELATED APPLICATIONS

This application is related to, and claims priority to, U.S. Provisional Application No. 62/416,096, filed on Nov. 1, 2016, and entitled “Enhanced Is-Typing Indicator,” the entirety of which is hereby incorporated by reference.

### TECHNICAL BACKGROUND

Many messaging applications provide an “is-typing” indicator in their user interface to represent to a user that another user on the far-end of a conversation is presently typing a message. This creates a positive experience for the near-end user, so that the user need not wonder whether the other user is replying to his or her message.

The is-typing indicator in some implementations is a series of animated dots or ellipses. The ellipses are animated in such a fashion that they appear to move through a cycle. However, the cycle is repetitive and sometimes gives the impression that the application is stuck, stalled, or otherwise does not accurately represent the behavior of the user on the far-end of the conversation.

To facilitate the is-typing effect, a far-end client provides its state to the near-end client and the near-end client drives the animation in its user interface accordingly. For example, the ellipses may begin to cycle when the far-end user is typing and stop their cycle (and potentially disappear) when the typing stops.

### OVERVIEW

Technology is disclosed herein that improves the user experience with respect to is-typing animations. In an implementation, a near-end client application receives an indication that a user is typing in a far-end client application. The near-end client application responsively selects an animation that is representative of a typing pattern. The selection may be random in some implementations (or pseudo random), or the selection may correspond to a particular typing pattern. The near-end client then manipulates the ellipses in its user interface to produce the selected animation.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 an operational environment in an implementation.

FIG. 2 illustrates a process in an implementation.

FIG. 3 illustrates a process in an implementation.

FIG. 4 illustrates an operational scenario in an implementation.

FIG. 5 illustrates an operational sequence in an implementation.

FIG. 6 illustrates an operational sequence in an implementation.

FIG. 7 illustrates an operational sequence in an implementation.

FIG. 8 illustrates various animations in an implementation.

FIG. 9 illustrates a computing system suitable for implementing the technology disclosed herein, including any of the environments, elements, processes, and operational scenarios and sequences illustrated in the Figures and discussed below in the Technical Disclosure.

### TECHNICAL DISCLOSURE

Technology is disclosed herein that improves the user experience with respect to is-typing animations. In an implementation, a near-end client application receives an indication that a user is typing in a far-end client application. The near-end client application responsively selects an animation that is representative of a typing pattern. The selection may be random in some implementations (or pseudo random), or the selection may correspond to a particular typing pattern. The near-end client then manipulates the ellipses in its user interface to produce the selected animation.

In some implementations, it is the far-end client application (in which the user is typing) that selects the animation. In such an implementation, the far-end client picks the animation either randomly or based on a correspondence between typing patterns and potential animations. The far-end client may then communicate to the near-end client which animation was selected, so that the near-end client can produce the animation.

The animation that is selected may include various sub-animations that together result in the macro-animation. For example, the ellipses may be made up of four dots, each of which is animated separately from each other. Thus, the animation of the ellipses can be produced by four separate animations.

In fact, when the animation is produced from four sub-animations, each sub-animation may be selected randomly from a set of possible animations. In such an implementation, any instance of is-typing animation—especially within the context of a single conversation—is likely to differ from any other instance of the is-typing animation. This is because the odds of producing the same animation from one instance to another is relatively low, assuming each sub-animation is randomly selected.

In the aggregate, the random selection of animations and/or sub-animations may give the effect to the near-end user of corresponding to actual typing. In some implementations, the ellipses are animated in such a way as to give the visual impression that they are being depressed, or pressed down, which further enhances the effect.

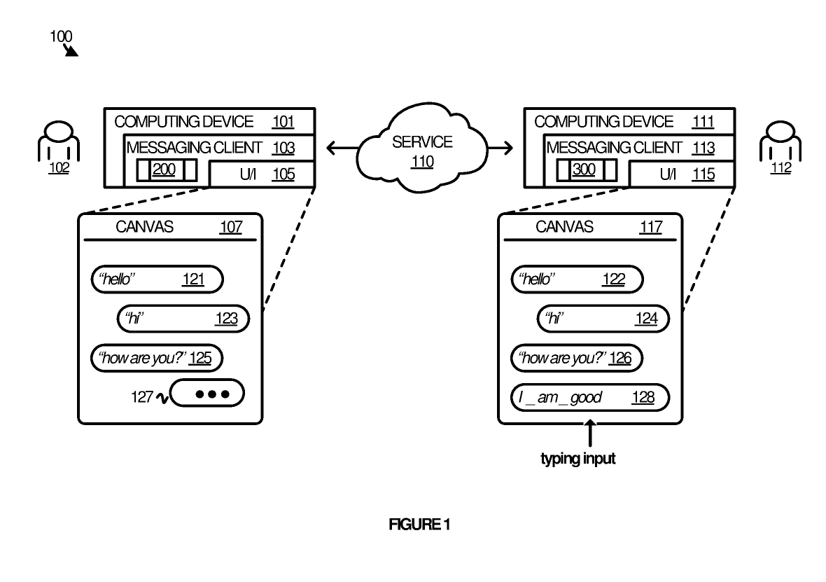

FIG. 1 illustrates an operational environment 100 in an implementation. Operational environment 100 includes computing device 101 and computing device 111. Messaging client 103 runs on computing device 101 and renders a user interface 105 to the client. Likewise, messaging client 113 runs on computing device 111 and renders user interface 115.

Messaging client 103 and messaging client 113 are representative of software applications that users may engage with to communicate with each other. Examples include, but are not limited to, instant messaging applications, short-message-service (SMS) applications, email applications, or any other suitable application. Messaging clients 103 and 113 may be stand-alone applications or may be components of other applications.

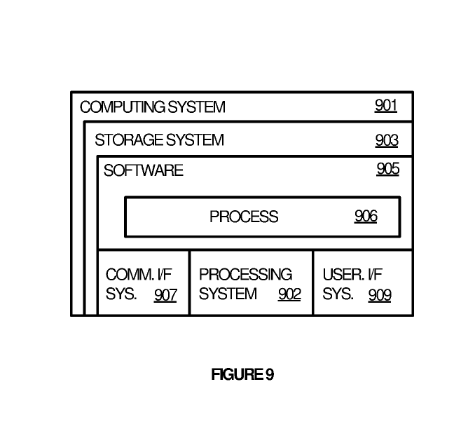

Computing devices 101 and 111 are representative of any device capable of hosting a messaging application, of which computing system 901 in FIG. 9 is representative. Examples include, but are not limited to, mobile phones, tablets, laptop computers, desktop computers, hybrid form factor devices, and any other variation or combination of device.

In operation, user 102 engages with user 112 in a messaging conversation. Each user interacts with a canvas in their respective user interface, represented by canvas 107 and canvas 117. The users input messages through their user interfaces (e.g. by typing) and the messages are communicated via service 110 to the opposite end of the conversation.

From the perspective of each client, the other client is the far-end of the conversation while a given client is the near-end. For exemplary purposes, it is assumed herein that messaging client 103 is the near-end client, while messaging client 113 is the far-end client.

In the course of the conversation, the users exchange messages, represented by messages 121, 122, 123, 124, 125, and 126. There may be pauses in messaging, during which one user may desire to know whether the other user is typing a message. In this example, user 102 recently typed and submitted message 125 and user 112 is responding.

User 112 responds by typing text into input box 128. The typing input is captured by messaging client 113 and is ultimately communicated in a new message for delivery to messaging client 103.

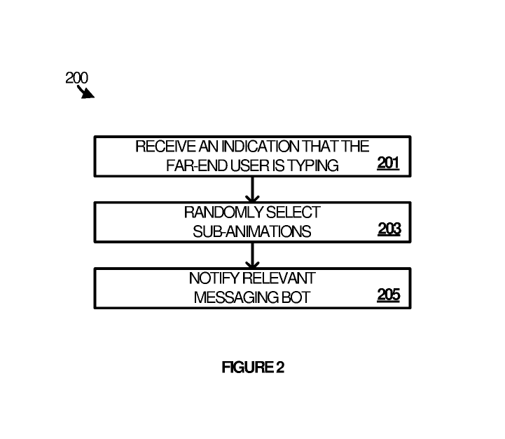

In the meantime, messaging client 103 may execute process 200, the steps of which are illustrated in more detail in FIG. 2. Referring to the steps of FIG. 2, messaging client receives an indication that user 112 is typing (step 201). The indication may be provided by messaging client 113. Messaging client 103 then randomly selects an animation to drive the is-typing indicator 127 in canvas 107 (step 203). Selecting the animation may include selecting just one animation for the entire indicator or selecting multiple animations for the individual components of the indicator. Having selected the animation, messaging client 103 then produces or renders the animation on canvas 107 (step 203).

Alternatively, messaging client 113 could employ process 300. In such a scenario, messaging client 113 would detect that user 112 is typing (step 301). Messaging client 113 would then randomly select the animation to be produced by messaging client 103 (step 303). Having selected the animation, messaging client 113 would then forward an indication of the animation to messaging client (step 305).

In a variation to process 300, the animation selection could be non-random. Rather, the selection could be based on a typing pattern detected in user interface 115. For instance, a fast typing pattern could correspond to one animation (or set of sub-animations), while a slow typing pattern could correspond to a different animation (or a different set of animations. In another example, specific words or phrase could correspond to one animation (or set of sub-animations), while different words or phrases being typed could correspond to a different animation (or a different set of animations).

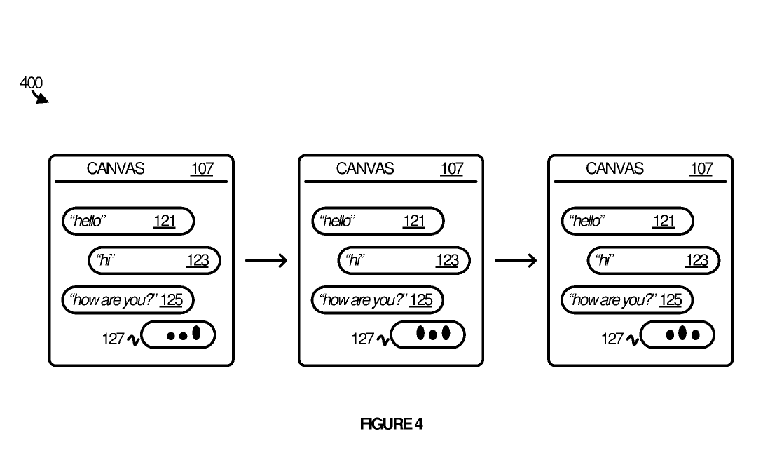

FIG. 4 illustrates an operational scenario 400 in an implementation described with respect to operational environment 100. In operational scenario 400, the is-typing indicator 127 in user interface 105 is animated to reflect that a user on the far-end of a conversation is typing a message to be sent to the near-end user. The shape of the ellipses in the is-typing indicator are deformed, in a sense, to visually represent that the user on the far-end is typing.

From one state to the next, for example, each ellipse is changes its shape just slightly. In the aggregate, the animation may give the impression to the user of keys being depressed on a keyboard.

Each individual ellipse may be animated by a different sub-animation than the others. For example, the first ellipse on the right in the is-typing indicator 127 may be driven by one sub-animation, the middle ellipse may be driven by another sub-animation, and the left-most ellipse may be driven by yet another sub-animation. Using different sub-animations for each ellipse may ensure that the overall animation is not repetitive and gives the impression that the ellipses are following the typing pattern of the far-end user.

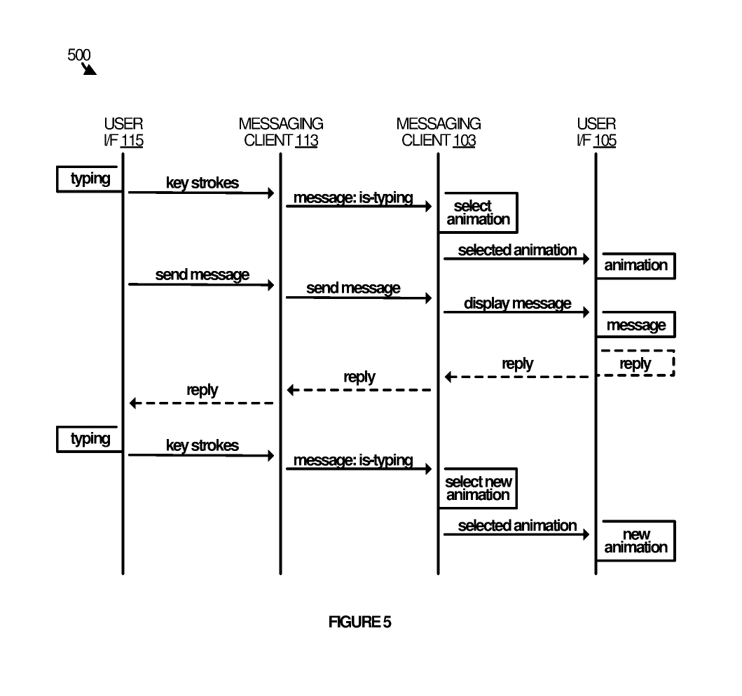

FIG. 5 illustrates an operational sequence 500 in an implementation described with respect to operational environment 100. In operation, the user 112, positioned at computing device 111, types in user interface 115. User 112 may provide typing input by way of a keyboard, a soft keyboard, voice input, or any other suitable input mechanism.

As the user 112 types, the key strokes are communicated to messaging client 113. Messaging client 113 responsively sends a message to messaging client 103 indicative of the “is-typing” status of user 112. Messaging client 103 receives the messages and selects an animation with which to indicate the is-typing status. The animation is played out in user interface 105 to user 102.

User 112 may eventually complete the message and, in so doing, cause messaging client 113 to send the message to messaging client 103. Messaging client 103 receives the messages and displays it in user interface 105. User 102 may optionally reply to the message, during the composition of which messaging client 113 may also display and “is-typing” animation in user interface 115.

Regardless of whether user 102 replies, user 112 may begin again to compose another message. Accordingly, key strokes are captured in user interface 115 and communicated to messaging client 113 and messaging client 113 responsively sends a message indicative of its is-typing state. Messaging client 103 receives the message and may select a new animation that differs from the initial animation. The new animation is rendered in user interface 105 to indicate to user 102 that user 112 is composing a message.

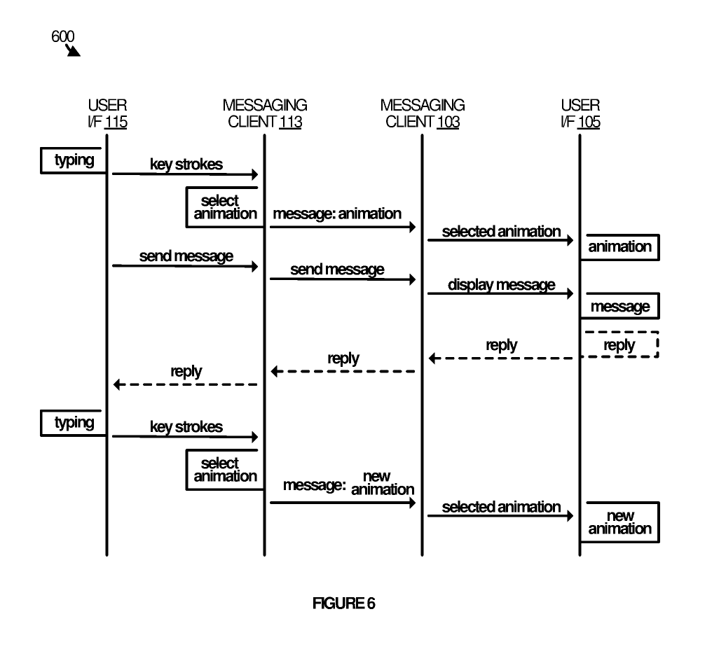

FIG. 6 illustrates an operational sequence 600 in an alternative implementation described with respect to operational environment 100. In operation, the user 112, positioned at computing device 111, types in user interface 115. User 112 may provide typing input by way of a keyboard, a soft keyboard, voice input, or any other suitable input mechanism.

As the user 112 types, the key strokes are communicated to messaging client 113. Messaging client 113 detects that the user is composing a message but has not yet hit “send,” or some other button, and responsively selects an animation representative of the user's typing. Messaging client 113 then sends a message to messaging client 103 indicative of the selected animation, although the actual animation is not sent. Rather, a code, identifier, or some other instruction is sent to messaging client 103 that references the selected animation. Messaging client 103 receives the messages and plays out the animation identified in the message via user interface 105 to user 102.

User 112 may eventually complete the message and, in so doing, cause messaging client 113 to send the message to messaging client 103. Messaging client 103 receives the messages and displays it in user interface 105. User 102 may optionally reply to the message, during the composition of which messaging client 113 may also display and “is-typing” animation in user interface 115.

Regardless of whether user 102 replies, user 112 may begin again to compose another message. Accordingly, key strokes are captured in user interface 115 and communicated to messaging client 113. Messaging client again selects an animation that is representative of the user's typing. Assuming the typing differs from the earlier typing, the animation may also differ.

Messaging client 113 sends a message to messaging client 103 that identifies the new animation to be played out. Messaging client 103 receives the message and renders the new animation in user interface 105, at least until the typing stops or a completed message is received.

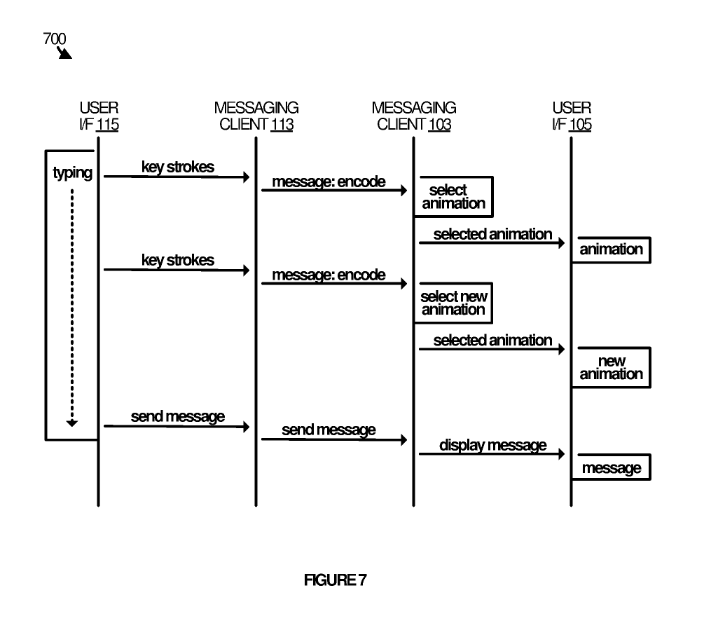

FIG. 7 illustrates an operational sequence 700 in one more alternative implementation described with respect to operational environment 100. In operation, the user 112, positioned at computing device 111, types in user interface 115. User 112 may provide typing input by way of a keyboard, a soft keyboard, voice input, or any other suitable input mechanism.

As the user 112 types, the key strokes are communicated to messaging client 113. Messaging client 113 responsively encodes the key strokes in such a way that the pace, spacing, and/or other characteristics of the typing may be embodied in a code. The code is then sent to messaging client 103. Messaging client 103 selects an animation based on the code and renders the selected animation in user interface 105.

As the user's typing continues, additional encoding may be performed by messaging client 113 and additional codes may be communicated to messaging client 103. Messaging client 103 may responsively select new animations (or the same) with which to drive the is-typing indicator in user interface 105. In other words, the animation may change from one animation to another, even during one continuous period typing by user 112 during which no messages are sent. Eventually, user 112 may complete the message, in which case it is sent by messaging client 113 to messaging client 103, for display in user interface 105.

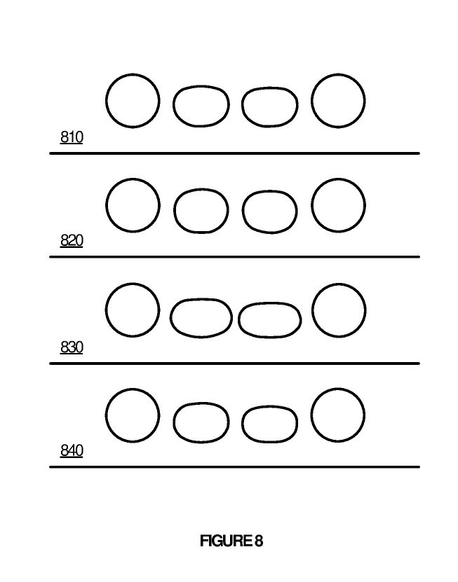

FIG. 8 illustrates four different animations that could be possible for each ellipse in an is-typing indicator. In this implementation, a typing indicator is comprised of four randomly triggered animations. Each of the animations contains varying levels of shape deformation and distance traveled. The algorithm randomly triggers which of the four animations play next for a given one of the three ellipses in an is-typing indicator. This gives an organic human feeling alluding to the act of typing on a keyboard.

For example, animation 810 illustrates one ellipse that is deformed somewhat from its first state to a next state, and then from the next state to a third state. Finally, the ellipse returns to its original shape.

In animation 820, the ellipse begins in its normal state, is barely deformed in the next state (less so than the second state in animation 810), then a bit more in its third state, and then returns to its original state.

In animation 830, the ellipse beings in its normal state, is deformed more so than in the first states of animation 810 and animation 820, transitions to a further-deformed state, and then returns to its original state. The third state of the ellipse in animation 830 is deformed more than any other state in either animation 810 or animation 820.

In animation 840, the ellipse beings in its original state and is deformed moderately in the second state, although slightly differently than the second state of animations 810, 820, and 830. The ellipse is then deformed slightly more, before returning to its original state.

It may thus be appreciated that the second and third states of deformation each animation differ relative to second and third states in each other animation. As discussed above, a given animation may be comprised of multiple sub-animations. Each sub-animation in an animation may drive how a single ellipse is animated. Each ellipse may thus be animated differently than the others.

Using the animations in FIG. 8 as an example, along with a set of three ellipses in an is-typing indicator, three of the four animations may be randomly or deterministically selected and assigned to the ellipses. For instance, animation 810 may be assigned to a first one of the three ellipses; animation 820 may be assigned to a second one of the three ellipses; and animation 830 may be assigned to a third one of the three ellipses, with animation 840 being left out of the animation.

When the animation is run, each one of the three ellipses will be animated slightly differently than the other two. This may give the ellipses a visual effect of tracking the typing of the user on the far-end, even if the animations are selected randomly. At the least, the animations have the technical effect of being be less repetitive and possibly more distinctive to the user than otherwise, thereby saving the user from replying too soon or mistakenly ignoring the far-end user.

FIG. 9 illustrates computing system 901, which is representative of any system or collection of systems in which the various applications, services, scenarios, and processes disclosed herein may be implemented. Examples of computing system 901 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

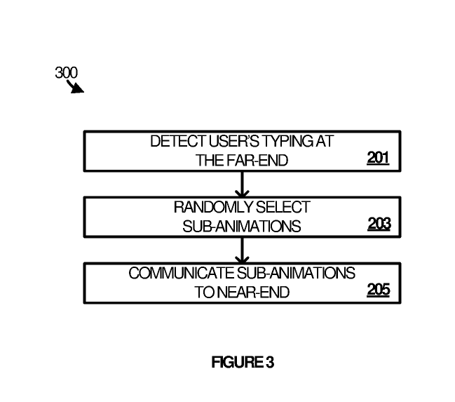

Processing system 902 loads and executes software 905 from storage system 903. Software 905 includes process 906, which is representative of the processes discussed with respect to the preceding FIGS. 1-8, including processes 200 and 300. When executed by processing system 902, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 5, processing system 902 may comprise a micro-processor and other circuitry that retrieves and executes software 905 from storage system 903. Processing system 902 may be implemented within a single processing device, but may also be distributed across multiple processing devices or sub-systems that cooperate in executing program instructions. Examples of processing system 902 include general purpose central processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device, but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtual machine software, or other application software, in addition to or that include process 906. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to provide enhanced is-typing indicators. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 902 in support of the various user input and output devices discussed above. Separately or in conjunction with each other and other hardware and software elements, the user interface software and user interface devices may support a graphical user interface, a natural user interface, or any other type of user interface.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Certain inventive aspects may be appreciated from the foregoing disclosure, of which the following are various examples.

### Example 1

An apparatus comprising: one or more computer readable storage media; a processing system operatively coupled to the one or more computer readable storage media; and an application comprising program instructions stored on the one or more computer readable storage media that, when executed by the processing system to provide an is-typing animation, direct the processing system to at least: render a messaging conversation in a user interface to the application for consumption by a user on a near-end of the messaging conversation; receive an indication of typing by a user on a far-end of the messaging conversation; identify an animation to represent a pattern of the typing by the user on the far-end of the messaging conversation; and render the animation in the user interface to the application.

### Example 2

The apparatus of Example 1 wherein the animation comprises a plurality of sub-animations of a plurality of shapes in the user interface, and wherein each of the plurality of sub-animations comprises one of a plurality of possible sub-animations.

### Example 3

The apparatus of Examples 1-2 wherein each sub-animation of the plurality of sub-animations animates a corresponding shape of the plurality of shapes, and wherein the plurality of shapes comprises a plurality of ellipses arranged horizontally.

### Example 4

The apparatus of Examples 1-3 wherein, to identify the animation, the program instructions direct the processing system to parse a message received from the far-end that identifies which one or more of the plurality of sub-animations represent the pattern of the typing.

### Example 5

The apparatus of Examples 1-4 wherein, to identify the animation to represent the pattern, the program instructions direct the processing system to select each of the plurality of sub-animations from the plurality of possible sub-animations.

### Example 6

The apparatus of Examples 1-5 wherein the program instructions direct the processing system to select each of the plurality of sub-animations based at least on the pattern of the typing by the user on the far-end of the messaging conversation.

### Example 7

The apparatus of Examples 1-6 wherein, to receive the indication of the typing, the program instructions direct the processing system to receive a message from the far-end of the messaging conversation that indicates at least the pattern of the typing.

### Example 8

The apparatus of Examples 1-7 wherein the program instructions direct the processing system to randomly select each of the plurality of sub-animations from the plurality of possible sub-animations.

### Example 9

One or more computer readable storage media having an application stored thereon comprising program instructions that, when executed by a processing system, direct the processing system to at least: render a messaging conversation in a user interface to the application for consumption by a user on a near-end of the messaging conversation; receive an indication of typing by a user on a far-end of the messaging conversation; identify an animation to represent a pattern of the typing by the user on the far-end of the messaging conversation; and render the animation in the user interface to the application.

### Example 10

The one or more computer readable storage media of Example 9 wherein the animation comprises a plurality of sub-animations of a plurality of shapes in the user interface, and wherein each of the plurality of sub-animations comprises one of a plurality of possible sub-animations.

### Example 11

The one or more computer readable storage media of Examples 9-10 wherein each sub-animation of the plurality of sub-animations animates a corresponding shape of the plurality of shapes, and wherein the plurality of shapes comprises a plurality of ellipses arranged horizontally.

### Example 12

The one or more computer readable storage media of Examples 9-11 wherein, to identify the animation, the program instructions direct the processing system to parse a message received from the far-end that identifies which one or more of the plurality of sub-animations represent the pattern of the typing.

### Example 13

The one or more computer readable storage media of Examples 9-12 wherein, to identify the animation to represent the pattern, the program instructions direct the processing system to select each of the plurality of sub-animations from the plurality of possible sub-animations.

### Example 14

The one or more computer readable storage media of Examples 9-13 wherein the program instructions direct the processing system to select each of the plurality of sub-animations based at least on the pattern of the typing by the user on the far-end of the messaging conversation.

### Example 15

The one or more computer readable storage media of Examples 9-14 wherein, to receive the indication of the typing, the program instructions direct the processing system to receive a message from the far-end of the messaging conversation that indicates at least the pattern of the typing.

### Example 16

The one or more computer readable storage media of Examples 9-15 wherein the program instructions direct the processing system to randomly select each of the plurality of sub-animations from the plurality of possible sub-animations.

### Example 17

A method of operating an application on a near-end of a messaging conversation, the method comprising: rendering the messaging conversation in a user interface to the application for consumption by a user on the near-end of the messaging conversation; receiving an indication of typing by a user on a far-end of the messaging conversation; identifying an animation to represent a pattern of the typing by the user on the far-end of the messaging conversation; and rendering the animation in the user interface to the application.

### Example 18

The method of Example 17 wherein the animation comprises a plurality of sub-animations of a plurality of shapes in the user interface, wherein each of the plurality of sub-animations comprises one of a plurality of possible sub-animations, and wherein each sub-animation of the plurality of sub-animations animates a corresponding shape of the plurality of shapes.

### Example 19

The method of Examples 17-18 wherein identifying the animation comprises parsing a message received from the far-end that identifies which one or more of the plurality of sub-animations represent the pattern of the typing.

### Example 20

The method of Examples 17-20 wherein identifying the animation to represent the pattern comprises selecting each of the plurality of sub-animations from the plurality of possible sub-animations.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. An apparatus comprising:
one or more computer readable storage media;
a processing system operatively coupled to the one or more computer readable storage media; and
an application comprising program instructions stored on the one or more computer readable storage media that, when executed by the processing system to provide an is-typing animation, direct the processing system to at least:
render a messaging conversation in a user interface to the application for consumption by a user on a near-end of the messaging conversation;
receive an indication of typing by a user on a far-end of the messaging conversation;
identify an animation to represent a pattern of the typing by the user on the far-end of the messaging conversation; and
render the animation in the user interface to the application.

2. The apparatus of claim 1 wherein the animation comprises a plurality of sub-animations of a plurality of shapes in the user interface, and wherein each of the plurality of sub-animations comprises one of a plurality of possible sub-animations.

3. The apparatus of claim 2 wherein each sub-animation of the plurality of sub-animations animates a corresponding shape of the plurality of shapes, and wherein the plurality of shapes comprises a plurality of ellipses arranged horizontally.

4. The apparatus of claim 3 wherein, to identify the animation, the program instructions direct the processing system to parse a message received from the far-end that identifies which one or more of the plurality of sub-animations represent the pattern of the typing.

5. The apparatus of claim 3 wherein, to identify the animation to represent the pattern, the program instructions direct the processing system to select each of the plurality of sub-animations from the plurality of possible sub-animations.

6. The apparatus of claim 5 wherein the program instructions direct the processing system to select each of the plurality of sub-animations based at least on the pattern of the typing by the user on the far-end of the messaging conversation.

7. The apparatus of claim 6 wherein, to receive the indication of the typing, the program instructions direct the processing system to receive a message from the far-end of the messaging conversation that indicates at least the pattern of the typing.

8. The apparatus of claim 5 wherein the program instructions direct the processing system to randomly select each of the plurality of sub-animations from the plurality of possible sub-animations.

9. One or more computer readable storage media having an application stored thereon comprising program instructions that, when executed by a processing system, direct the processing system to at least:
render a messaging conversation in a user interface to the application for consumption by a user on a near-end of the messaging conversation;
receive an indication of typing by a user on a far-end of the messaging conversation;
identify an animation to represent a pattern of the typing by the user on the far-end of the messaging conversation; and
render the animation in the user interface to the application.

10. The one or more computer readable storage media of claim 9 wherein the animation comprises a plurality of sub-animations of a plurality of shapes in the user interface, and wherein each of the plurality of sub-animations comprises one of a plurality of possible sub-animations.

11. The one or more computer readable storage media of claim 10 wherein each sub-animation of the plurality of sub-animations animates a corresponding shape of the plurality of shapes, and wherein the plurality of shapes comprises a plurality of ellipses arranged horizontally.

12. The one or more computer readable storage media of claim 11 wherein, to identify the animation, the program instructions direct the processing system to parse a message received from the far-end that identifies which one or more of the plurality of sub-animations represent the pattern of the typing.

13. The one or more computer readable storage media of claim 11 wherein, to identify the animation to represent the pattern, the program instructions direct the processing system to select each of the plurality of sub-animations from the plurality of possible sub-animations.

14. The one or more computer readable storage media of claim 13 wherein the program instructions direct the processing system to select each of the plurality of sub-animations based at least on the pattern of the typing by the user on the far-end of the messaging conversation.

15. The one or more computer readable storage media of claim 14 wherein, to receive the indication of the typing, the program instructions direct the processing system to receive a message from the far-end of the messaging conversation that indicates at least the pattern of the typing.

16. The one or more computer readable storage media of claim 13 wherein the program instructions direct the processing system to randomly select each of the plurality of sub-animations from the plurality of possible sub-animations.

17. A method of operating an application on a near-end of a messaging conversation, the method comprising:
rendering the messaging conversation in a user interface to the application for consumption by a user on the near-end of the messaging conversation;
receiving an indication of typing by a user on a far-end of the messaging conversation;
identifying an animation to represent a pattern of the typing by the user on the far-end of the messaging conversation; and
rendering the animation in the user interface to the application.

18. The method of claim 17 wherein the animation comprises a plurality of sub-animations of a plurality of shapes in the user interface, wherein each of the plurality of sub-animations comprises one of a plurality of possible sub-animations, and wherein each sub-animation of the plurality of sub-animations animates a corresponding shape of the plurality of shapes.

19. The method of claim 17 wherein identifying the animation comprises parsing a message received from the far-end that identifies which one or more of the plurality of sub-animations represent the pattern of the typing.

20. The method of claim 17 wherein identifying the animation to represent the pattern comprises selecting each of the plurality of sub-animations from the plurality of possible sub-animations.
